(19) United States
(12) Patent Application Publication
(10) Pub. No.: US 2026/0292482 A1
(43) Pub. Date: Sep. 24, 2026

(54) METHODS FOR PROVIDING IP PREFIXES USING EXISTING PC5 LINK

(71) Applicant: InterDigital Patent Holdings, Inc., Wilmington, DE (US)

(72) Inventors: Michelle PERRAS, Montreal (CA); Samir FERDI, Kirkland (CA); Taimoor ABBAS, Sainte-Julie (CA); Magurawalage Chathura Madhusanka SARATHCHANDRA, London (GB); Jung Je SON, Warrington, PA (US); Saad AHMAD, Montreal (CA)

(73) Assignee: InterDigital Patent Holdings, Inc., Wilmington, DE (US)

(21) Appl. No.: 19/472,515

(22) PCT Filed: Apr. 5, 2024
(86) PCT No.: PCT/US2024/023324

§ 371 Date: Oct. 3, 2025

Related U.S. Application Data
(60) Provisional application No. 63/457,710, filed on Apr. 6, 2023.

(51) Int. Cl. H04W 8/26; H04W 76/20; H04W 88/04

(52) U.S. Cl. CPC H04W 8/26; H04W 76/20; H04W 88/04

(57) ABSTRACT

Methods for providing prefix information to a remote wireless transmit/receive unit (WTRU) are described herein. A method may include sending or receiving, over a link to the remote WTRU, protocol data units (PDUs) including a first IP address associated with a PDU session utilizing session service and session continuity mode 3 (SSC3). The method may include receiving a message for modification of the PDU session indicating reactivation is requested and sending a message for modification of the PDU session. The method may include receiving new IP prefix information, sending a message including the new IP prefix information over the link to the remote WTRU, and sending or receiving PDUs over the link to the remote WTRU, the PDUs including a second IP address generated based on the new IP prefix information. WO

### CROSS-REFERENCE TO RELATED APPLICATIONS

This application claims the benefit of U.S. Provisional Application No. 63/457,710, filed Apr. 6, 2023, the contents of which are incorporated herein by reference.

### BACKGROUND

In cellular networks operating in accordance Third Generation Partnership Project (3GPP) technical specifications for Fifth Generation (5G) standards, an integral aspect of data services is session and service continuity, ensuring a seamless user experience regardless of changes in the user's internet protocol (IP) address or shifts in the core network anchor point.

In the 4G Long Term Evolution (LTE) evolved packet system, IP session continuity may be upheld by preserving the IP addresses of both the P-GW and the user's protocol (PDU) session, regardless of mobility events. However, not all applications may require assured IP session continuity, even if service continuity remains essential. With the advent of 5G, the network can offer increased flexibility by providing various types of session continuity tailored to the WTRU or service types.

To cater to diverse continuity requirements of different applications and services, the 5G System architecture introduces three Session and Service Continuity (SSC) modes. Once an SSC mode is designated to a PDU Session, it remains fixed throughout the session's duration. The 5G architecture empowers applications to influence the selection of SSC modes according to the specific demands of the data service.

### SUMMARY

Methods for providing prefix information to a remote wireless transmit/receive unit (WTRU) are described herein. A method may include sending or receiving, over a link to the remote WTRU, protocol data units (PDUs) including a first IP address associated with a PDU session utilizing session service and session continuity mode 3 (SSC3). The method may include receiving a message for modification of the PDU session indicating reactivation is requested and sending a message for modification of the PDU session. The method may include receiving new IP prefix information, sending a message including the new IP prefix information over the link to the remote WTRU, and sending or receiving PDUs over the link to the remote WTRU, the PDUs including a second IP address generated based on the new IP prefix information.

### DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of a procedure for PC5 link release based on a cause code;

FIG. 3 is a diagram illustrating several solutions for PDU session establishment/reestablishment in a Relay WTRU provides IP prefix information to a Remote WTRU;

FIG. 4 is a diagram illustrating an exemplary procedure performed upon receiving a “new PC5 link” indication (MBB PC5 link); and

FIG. 5 is a flow chart illustrating a method for link release and re-establishment initiated based on a cause value included provided by a relay WTRU;

FIG. 6 is a flow chart illustrating a method performed by a Relay WTRU for providing IP prefixes to a Remote WTRU; and

FIG. 7 is a flowchart illustrating a method performed by a Remote WTRU carrying out a make-before-break procedure for link establishment.

### DETAILED DESCRIPTION

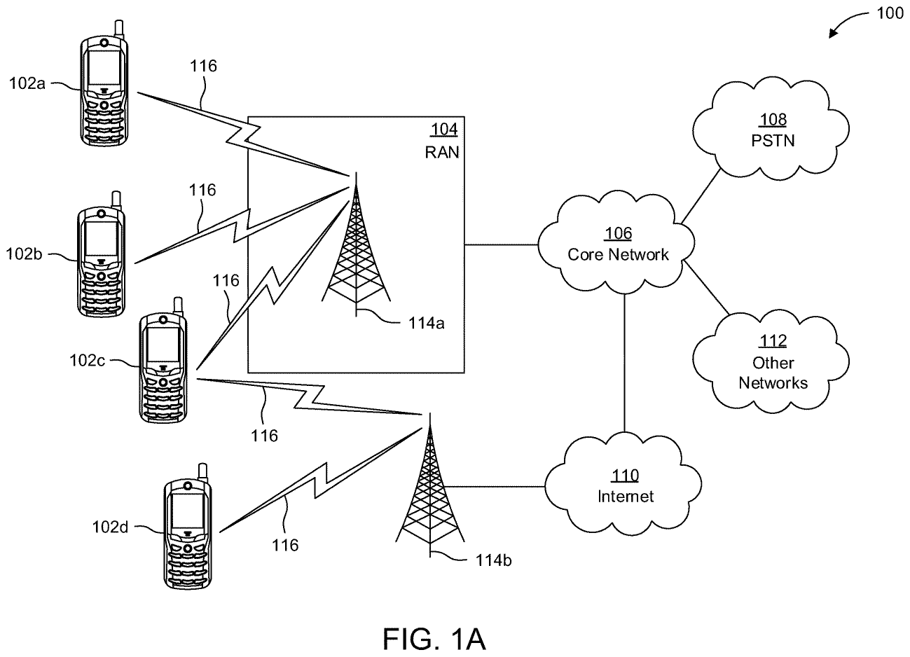

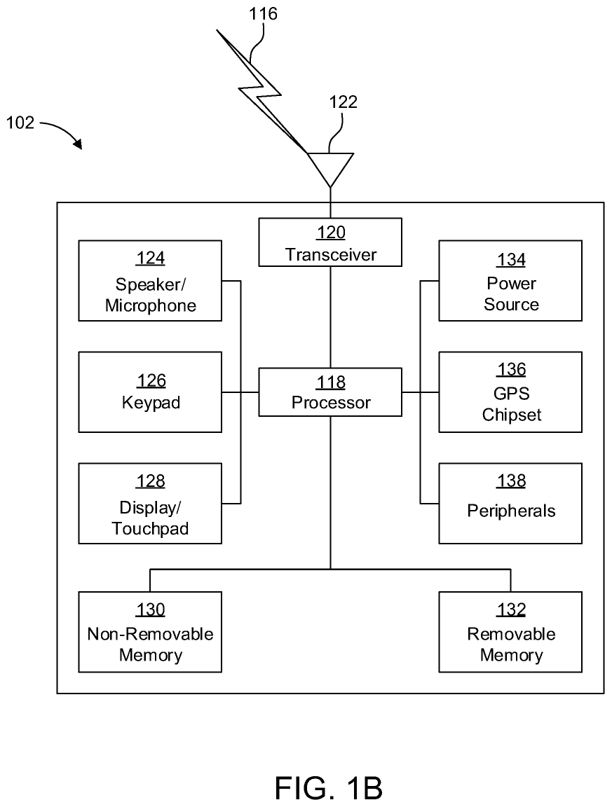

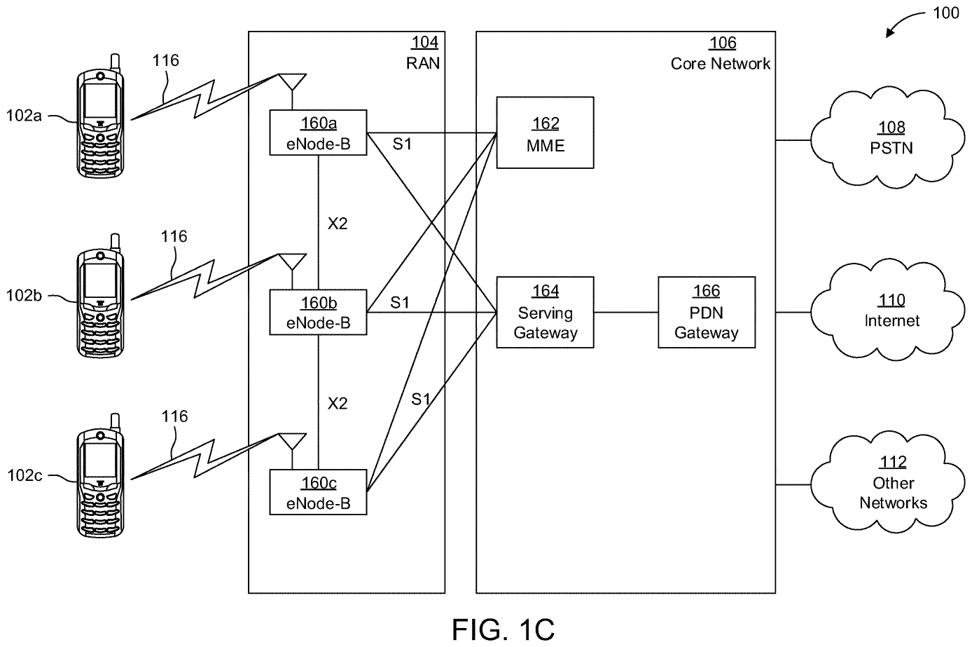

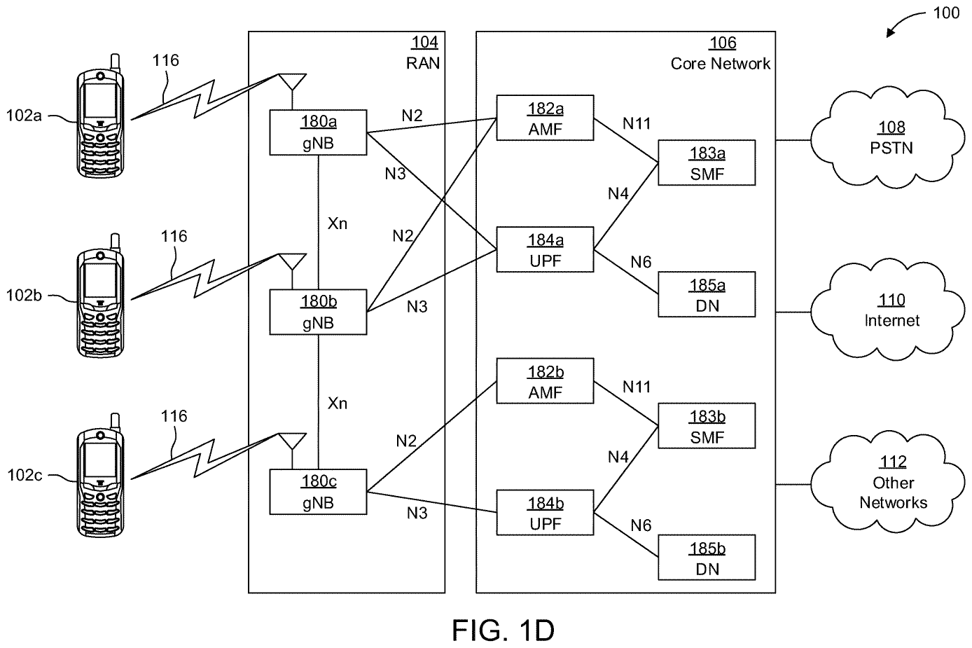

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUS 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A general description of session and service continuity (SSC) modes is provided in the following paragraphs. The 5G System architecture provides support for SSC, catering to the diverse continuity requirements of different applications/services. SSC modes, which remain constant throughout the lifespan of a PDU Session, are integral to the system. Three SSC modes are defined. SSC mode 1 (SSC1) may ensure that the network preserves WTRU connectivity, maintaining IP addresses for PDU Sessions of IPV4, IPv6, or IPv4v6 types. With PDU sessions utilizing SSC mode 2 (SSC2), the Network may release WTRU connectivity service and corresponding PDU Sessions, resulting in the release of allocated IP address(es) for IPV4, IPV6, or IPv4v6 type. SSC mode 3 (SSC3), on the other hand, may allow visible changes to the user plane for the WTRU while ensuring no loss of connectivity. The Network establishes a connection through a new PDU Session Anchor point before terminating an existing connection, which affords service continuity. However, IP address preservation is not guaranteed for IPV4, IPv6, or IPv4v6 type in SSC mode 3 when the PDU Session Anchor changes.

Recent proposals within Third Generation Partnership Project (3GPP) working groups address issues faced in PC5 communication and affects procedures in which a Relay WTRU (e.g., a layer 3 (L3) WTRU-to-Network (WTRU) Relay) reactivates or establishes a new protocol data unit (PDU) session. In some procedures, a L3 W2N Relay serving Remote WTRUs may reestablish a PDU session using SSC mode 3 after receiving a cause value, such as a 5G session management (5GSM) cause value (e.g., cause value #39 “reactivation requested”), as part of a PDU Session Modification procedure. In such cases, internet protocol (IP) addresses/prefixes used by the Remote WTRUs may be affected since preservation of the IP address following PDU session reestablishment may not be possible or permitted in SSC mode 3.

Solutions proposed herein may, for example, specify that the W2N Relay initiates the PC5 link release procedure after the new PDU session is established so that the Remote WTRU can establish a new PC5 link and be served using the new PDU session (i.e., Remote WTRU obtains new IP address associated with the new PC5 link & new PDU Session).

SSC3 is described in further detail herein. As described in 3GPP technical specifications (e.g., 23.501 and 23.502), when SSC3 is used, changes to the user plane may be visible to the WTRU, while the network ensures that the WTRU suffers no loss of connectivity.

A W2N Relay may reestablish a PDU session utilizing SSC3 after receiving an indication of a cause value (e.g., a 5GSM cause value #39 “reactivation requested”) as part of a PDU Session Modification procedure. Thus, a connection through a new PDU Session Anchor point is established before the previous connection is terminated in order to allow for better service continuity. This behavior may be referred to as “make before break” connection establishment. The IP address used prior to the establishment of the connection with the new PDU Session Anchor point may not be preserved when the PDU Session Anchor changes. The new Anchor may be associated with a new PDU Session or with the same PDU Session (such as in the case of a multi-homing PDU session). A multi-homing PDU session may be a PDU session that is associated with multiple PDU session anchors and/or multiple IP prefixes.

SSC3 operation with multiple PDU Sessions is described herein. In some situations, a new PDU Session may be established with a new Anchor. New prefixes may need to be sent to a Remote WTRU to make use of this new PDU Session/Anchor. Old prefixes may still be used for some time before an old PDU Session is released. A PDU session address lifetime may be provided as part of an PDU Session Modification procedure.

Procedures for changing a PDU Session Anchor (e.g., for a multi-homed PDU Session utilizing SSC3) are described herein. The IPV6 prefixes from the new Anchor may be associated with the existing PDU Session and may need to be sent to the Remote WTRU to use the new PDU Session Anchor. Old prefixes may still be used for some time.

SSC2 is further described herein. As described in 3GPP technical specifications (e.g., 23.501 and 23.502), when SSC mode 2 is used, the network may release connectivity service(s) provided to the WTRU and release corresponding PDU Session(s). The release of a PDU Session may induce the release of one or more IP addresses that had been allocated to the WTRU.

A W2N Relay may reestablish a PDU session utilizing SSC2 after receiving a cause value (e.g., a 5GSM cause value #39 “reactivation requested”) as part of a PDU Session Release procedure. Thus, a connection through a new PDU Session Anchor point may be established after the previous connection is terminated. This behavior may be referred to as “break-before make” connection establishment or reestablishment.

If a PDU Session has a single PDU Session Anchor, the network may trigger the release of the PDU Session and instruct the WTRU to establish a new PDU Session with the same data network immediately. If a PDU Session has multiple PDU Session Anchors (i.e., in the case of multi-homed PDU Sessions or in the case that an Uplink Classifier (UL CL) applies to a PDU Session), the additional PDU Session Anchors may be released or allocated. The term UL CL may refer to functionality supported by an UPF that aims at diverting (e.g., locally diversity) traffic matching filters provided by the SMF. The UL CL may enable forwarding of UL traffic towards different PDU Session Anchors and merging of DL traffic to the WTRU. For example, the UL CL may enable merging of traffic from the different PDU Session Anchors on the link towards the WTRU. This may be performed based on traffic detection and traffic forwarding rules provided by the SMF.

Allocation of a Remote WTRU IP address via a W2N Relay is described herein. When IPv6 is used, a Remote WTRU may support IPV6 stateless Address auto-configuration. The Remote WTRU may send a Router Solicitation (e.g., a solicitation message) and additionally, or alternatively, receive prefixes from the Relay via a Router Advertisement (e.g., an advertisement message). This may occur, for example, when a PC5 link is established. The Relay may obtain prefixes via prefix delegation from the Network when a PDU Session is established. In some examples, a Relay WTRU may assign prefixes to a Remote WTRU using a prefix range associated with the PDU Session.

The PC5 Link Release cause codes are described in further detail herein. Cause codes that may be sent with the PC5 Link Release message may include cause codes indicating: direct communication to the target WTRU is not allowed; a direct communication to the target WTRU is no longer needed; conflict of layer-2 ID for unicast communication is detected; a direct connection is not available anymore; a lack of resources for 5G ProSe direct link; authentication failure; integrity failure; WTRU security capabilities mismatch; conflict in bits or least significant bit(s) LSBs of a key (e.g., KNRP-sess) ID; WTRU PC5 unicast signaling security policy mismatch; required service is not allowed; security policy is not aligned; congestion situation; authentication synchronization error; security procedure failure of 5G ProSe WTRU-to-network relay; and/or a protocol error, unspecified.

Problems addressed by embodiments presented herein are described in the following paragraphs. One such problem concerns PC5 link release/re-establishment associated with a new PDU Session. Releasing/re-establishing a PC5 link as proposed in C1-230694 may work only if the Remote WTRU triggers a new PC5 link establishment with the same L3 W2N Relay. As described substantially in paragraphs above, the cause code “protocol error, unspecified” may be the only non-specific cause code currently available that could be used to release the PC5 link with the Remote WTRU when the W2N Relay receives GSM cause value #39 “reactivation requested” as part of a PDU Session Modification procedure or PDU Session Release procedure.

It is thus not clear how a Remote WTRU may determine to establish a new PC5 link with the same Relay after the PC5 link release is initiated by the Relay WTRU with the cause value “protocol error unspecified.” The default behavior in this situation may be triggering the W2N Relay Discovery procedure to find another available W2N Relay, since it may not be clear why the W2N Relay has initiated the PC5 link release.

A question answered by one or more of the solutions proposed herein may be how the Remote WTRU determines that a new PC5 link needs to be established with the same W2N Relay when receiving a PC5 link release request.

Another problem addressed by embodiments presented herein may concern the loss of connectivity at the Remote WTRU. Releasing a PC5 link and establishing a new PC5 link (as proposed in C1-230694) may enable the Remote WTRU to obtain a new IP address associated with the new PDU session; however, this may break connectivity for the Remote WTRU, which is not consistent with SSC3 behavior, (i.e., the network ensuring that the WTRU suffers no loss of connectivity) and the use of make-before-break allowing service continuity. A question answered by one or more of the solutions proposed herein may be how to preserve connectivity for a Remote WTRU connected to an L3 W2N Relay when the PDU Session Anchor of a PDU Session of SSC mode 3 is changed.

In the following description, the terms 5G ProSe WTRU-to-Network Relay, WTRU-to-Network Relay, W2N Relay, and/or Relay may be used interchangeably.

Solutions are proposed herein to enable a Remote WTRU to determine if a new PC5 link should be established with the same W2N Relay after the reception of a PC5 Link Release Request with “reactivation requested” cause value. Some solutions may define a PC5 Link Release Request message that includes a new cause code, “new PDU Session available.”

Furthermore, to preserve connectivity for Remote WTRU connected to L3 W2N Relay when the PDU Session Anchor of a PDU Session of SS3 is changed, various solutions are proposed. Some solutions are proposed in which an existing PC5 link with the Remote WTRU is maintained. The Relay WTRU may provide new prefixes to be used over this PC5 link. Some solutions are proposed in which a new PC5 link is established between the Remote WTRU and the Relay WTRU, in addition to the existing PC5 link. Benefits of these solutions may include maintenance of end-to-end session connectivity, i.e., between the Remote WTRU and the network (over PC5 and Uu interfaces) when SSC3 is used and minimization of interruption when SSC2 is used.

Various proposed solutions addressing at least the problems/questions detailed above are described in the following paragraphs.

In some solutions, a PC5 Link Release Request including a “new PDU Session available” cause value may be sent. The solutions proposed in the following paragraphs may resolve issues related to PC5 link release and/or re-establishment. In some solutions, a L3 W2N Relay may establish a new PDU session using SSC3 upon receiving a message that includes a cause value (e.g., 5GSM cause value #39 indicating “reactivation requested”) as part of the PDU Session Modification procedure. Alternatively, or additionally, an L3 W2N Relay may update an IPV6 prefix configuration of an existing PDU session utilizing SSC3 and change the PDU Session anchor. The W2N Relay may initiate an PC5 Link Release procedure after a new PDU Session is established (or after change of a PDU Session anchor) and may set the cause value to “new PDU Session available.” Based on the received PC5 link release cause value, the Remote WTRU may complete the PC5 Link Release procedure and trigger the PC5 unicast link establishment procedure with the same W2N Relay. The PC5 unicast link establishment procedure with the same W2N Relay may be triggered immediately following the reception of the PC5 link release cause value, or immediately following completion of the PC5 Link Release procedure. A new PC5 link may be established and an IP address associated with the new PDU Session may be allocated. A W2N Relay may preserve resources allocated to this Remote WTRU for some time to make sure it still has enough resources when the Remote WTRU re-establishes its PC5 connection. After some time, the W2N Relay may release the reserved resources and make them available for another Remote WTRU.

A PDU Session Modification procedure may be, for example, a network-initiated session modification procedure, or a WTRU-initiated session modification procedure. The PDU Session Modification procedure may involve an exchange of messages between a WTRU and the network. For example, the PDU Session Modification procedure may involve the CN (or a logical entity within the CN such as a session management function (SMF)) sending one or more messages or commands to a WTRU that includes the aforementioned cause value. The PDU Session Anchor as referred to herein may reference a UPF.

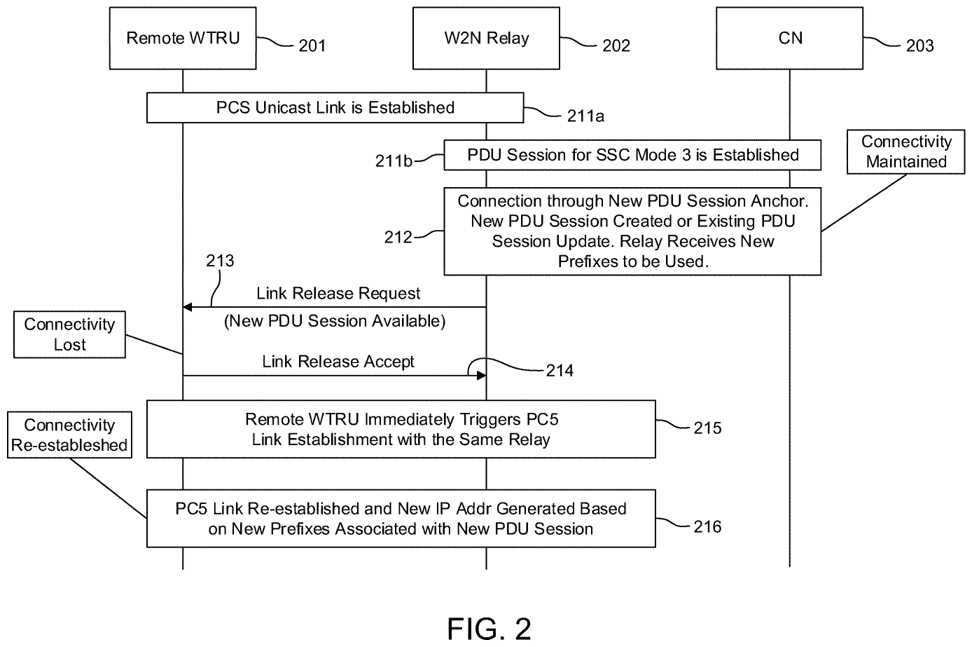

FIG. 2 is a diagram illustrating an example of a procedure for PC5 link release based on a cause code. The solution shown, involves the transmission/reception of a PC5 Link Release Request message including a new cause value. As shown in FIG. 2 at step 211a, a Remote WTRU 201 may have established a PC5 unicast link with the L3 W2N Relay WTRU 202. As shown at step 211b, the W2N Relay 202 may have established a PDU Session utilizing SSC mode 3 type (SSC3) for communication with the 5G CN 203. The L 3 W2N Relay 202 may establish a new PDU session utilizing SSC3 based on, or after receiving, a message including a 5GSM cause value (e.g., cause value #39 indicating “reactivation requested”) as part of the PDU Session Modification procedure. As part of the establishment of the new PDU session, the W2N Relay 202 establishes a connection with a new PDU Session Anchor at the CN 203, as shown at 212. Alternatively, or additionally, the L3 W2N Relay may update an IPV6 prefix configuration of an existing PDU session based on the use of SSC3 and change of the PDU Session anchor. The W2N Relay 202 may initiate the PC5 link release procedure after the new PDU session is established and, as shown at 213, may send a PC5 Link Release Request message to the Remote WTRU 201 that may include a cause value indicating “new PDU Session available”. The Remote WTRU 201 may complete the PC5 link release procedure. This may involve sending a response message, such as a PC5 Link Release Accept message shown in FIG. 2 at 214. Based on the received PC5 Link Release Request cause value, the Remote WTRU 201 may, at 215, immediately trigger the PC5 unicast link establishment procedure with the same W2N Relay. A new PC5 link may be established and an IP address associated with the new PDU session may be generated, as shown at 216.

In some iterations of the procedure shown in FIG. 2, an existing PDU session may utilize SSC2. In such cases, at step 212, the existing PDU Session may be released and a new PDU Session may be established. Connectivity over the Uu interface may not be maintained. The W2N Relay 202 may initiate the PC5 link release procedure (e.g., shown in step 213) prior to triggering the new PDU Session establishment procedure or prior to completion of the PDU Session establishment procedure, which may reduce the time during which the Remote WTRU 201 loses connectivity. Subsequent steps may remain the same as shown in FIG. 2 and described substantially above.

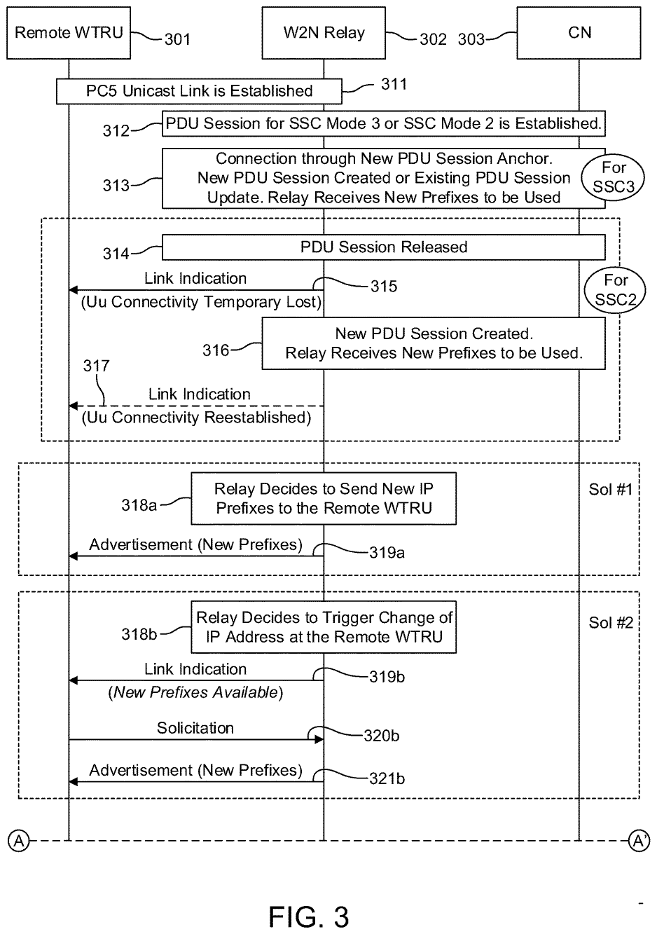

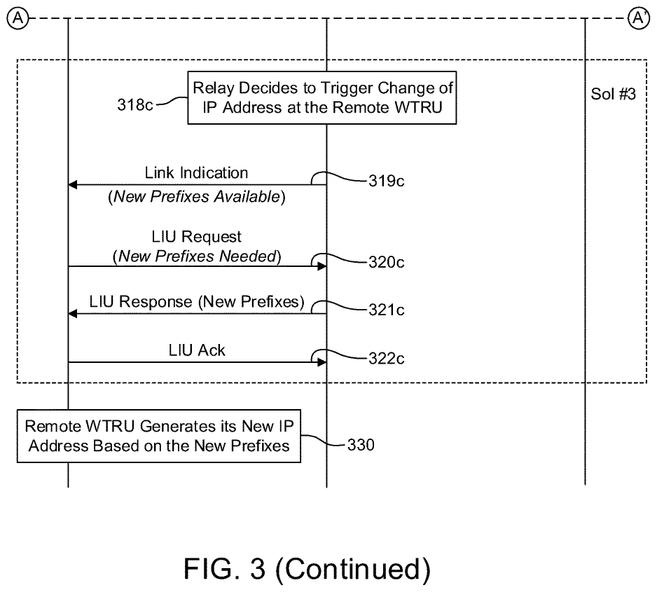

In some solutions, a W2N Relay provides new prefixes to the Remote WTRU 201 over the existing PC5 link. Using the solutions described in subsequent paragraphs and figures, (e.g., in steps 311-312 of FIG. 3, introduced and described in further detail below) a W2N Relay may re-establish a PDU session due to SSC3 after receiving a cause value (e.g., a 5GSM cause value #39 indicating “reactivation requested”) as part of the PDU Session Modification procedure or a procedure to change the PDU Session anchor of the existing PDU Session.

The existing PC5 unicast link between the Remote WTRU 201 and the W2N Relay 202 may be maintained and associated with new IPV6 prefixes. A Remote WTRU 201 may auto-generate a new IPV6 address using the new prefixes to make use of the new PDU Session Anchor. Alternatively, the PDU Session may be of a different SSC mode (e.g., SSC2). In such cases, the existing PDU Session may be released and a new PDU Session may be established. Connectivity over Uu interface may not be maintained. A Remote WTRU may be informed when connectivity on Uu interface is lost/re-established.

FIG. 3 is a diagram illustrating several solutions for PDU session establishment/reestablishment in a Relay WTRU provides IP prefix information to a Remote WTRU. As shown in FIG. 3 at 311, a PC5 unicast link may be established between the Remote WTRU 301 and the W2N Relay 302. The Remote WTRU 301 may send PDUs to the W2N Relay 302 for routing towards destinations within the network using the established PDU session. By the same token the Remote WTRU 301 may receive PDUs from the W2N Relay 302 using the established PDU session, which may be forwarded from other sources within the data network. As shown at 312, a PDU Session (e.g., a new PDU session) utilizing SSC3 or SSC2 may be established by the W2N Relay 302 and the CN 303. In the case where an existing PDU session has been created utilizing SSC3, the W2N Relay 302 may reestablish the PDU session or change the PDU Session Anchor to an existing PDU Session when the W2N Relay 302 has received a cause value (e.g., a 5GSM cause value #39 indicating “reactivation requested”) as part of the PDU Session Modification procedure. The W2N Relay 302 may receive new prefixes related to the new PDU Session Anchor.

In the case a new session is created utilizing SSC2, the existing PDU Session may first be released, as shown at 314. This may be carried out after the W2N Relay 302 receives a cause value from the CN 303 (e.g., a 5GSM cause value indicating #39 “reactivation requested” as part of the PDU Session Release procedure). The W2N Relay 302 may send a message to the Remote WTRU 301 indicating that Uu connectivity is temporarily lost, as shown at 315. The Remote WTRU 301 may pause data transfer. In some examples, an existing “keepalive” message sent from the W2N Relay 302 to the Remote WTRU may be modified to carry the indication that Uu connectivity is lost. Alternatively or additionally, a new PC5-S message may be used, e.g., PC5_Link Indication.

As shown at 316, the W2N Relay 302 may establish another PDU Session utilizing SSC2. The W2N Relay 302 may, at 317, inform (e.g., implicitly or explicitly via a message as is shown in FIG. 3) the Remote WTRU 301 that Uu connectivity is re-established. In the case where the W2N Relay 302 implicitly informs the Remote WTRU 301 that Uu connectivity is re-established, the message may not be sent.

In a first solution further illustrated in FIG. 3, new IP prefixes may be sent by the W2N Relay 302 over an existing PC5 link. As shown in steps 318a-319a, a W2N Relay 302 may autonomously decide to advertise new IPv6 prefixes over the existing PC5 link to the Remote WTRU 301 once the new PDU Session is established or modified with new prefixes. For example, the W2N Relay 302 may receive a cause value (e.g., a 5G cause value #39 indicating “reactivation requested”) as part of the PDU Session Modification or PDU Session Release procedure. The CN 303 may include the cause value in a message transmitted within the PDU Session Modification or PDU Session Release procedure. This may be interpreted as a trigger the W2N Relay 302 to advertise the new prefixes to the Remote WTRU 301, once the new PDU Session is established or once the existing PDU Session is modified.

As shown at 319a, the W2N Relay 302 may send an advertisement message to the Remote WTRU 301. The advertisement message may be sent multiple times to ensure the Remote WTRU 301 receives it. The Remote WTRU 301 receiving the new prefixes may auto-configure a new IPV6 address to be associated with the PC5 link and begin using its new IP address.

In a second set of examples illustrated in steps 318b-321b, a W2N Relay 302 may send new IP prefixes to a Remote WTRU 301 using an existing PC5 link. As shown at step 318b, the W2N Relay 302 may determine or decide that a change of IP address at the Remote WTRU 301 is necessary. The W2N Relay 302 may send a message that informs the Remote WTRU 301 that new prefixes are available. For example, as shown at step 319b, once the new PDU Session is established (or modified with new prefixes), the W2N Relay 302 may send a message (e.g., a PC5-S message) to the Remote WTRU 301 indicating that new prefixes are available.

The message may be a modified Keepalive or Link Modification message, including a new indication e.g., “new prefixes available”. Alternatively or additionally, a new PC5-S message (e.g., PC5_New Prefixes Available or PC5_Link Indication (new prefixes available) may be used. In this case, the indication message may be sent multiple times to make sure Remote WTRU receives it.

The Remote WTRU 301 may receive the PC5-S message from the W2N Relay 302 indicating that new prefixes are available. As shown at step 320b, based on the received indication, the Remote WTRU 301 may trigger an IP address configuration procedure to obtain new IPV6 prefixes and change its IP address. For example, the Remote WTRU 301 may send a Solicitation message to the W2N Relay 302, which may allow the Remote WTRU to initiate an IP address allocation procedure. As shown at 321b, the W2N Relay 302 may reply to a message received from the Remote WTRU by sending new prefixes in an Advertisement message. The Remote WTRU 301 receiving the Advertisement message may auto-configure itself with a new IPv6 address to be associated with the PC5 link and begin using this new IP address.

In a third set of examples illustrated in steps 318c-322c, the Remote WTRU triggers a PC5 Link Identifier Update (LIU) procedure based on an indication received from the W2N Relay 302. As is further shown in FIG. 3, at step 318c, once the new PDU Session is established or modified with new prefixes, the W2N Relay 302 may send a message (e.g., a PC5-S message) to the Remote WTRU 301 indicating that new prefixes are available. In some examples, this may be performed consistently with procedures and/or steps described above. As shown in step 319c, the Remote WTRU 301 may receive the message (e.g., a PC5-S message) from the W2N Relay 302 indicating that new prefixes are available. Based on the received indication, the Remote WTRU may trigger the LIU procedure. The reception of the message indicating that new prefixes are available may function as a new trigger at the Remote WTRU 301 to initiate the LIU procedure and new IP address configuration.

The Remote WTRU 301 may request new prefixes from the W2N Relay 302 by transmitting a message (e.g., a LIU request) shown at 320c including an indication that IP prefixes are needed. As shown at step 321c, the W2N Relay 302 may reply with a response message (e.g., a LIU Response), which may include new prefixes to be used with the new PDU Session Anchor. As shown at step 322c, the Remote WTRU 301 may complete the LIU procedure by sending an acknowledgment message (e.g., a LIU ACK message).

In accordance with each of the examples described paragraphs above, the Remote WTRU 301 receiving the new prefixes may, as shown at 330, auto-configure itself with a new IP address to be associated with the PC5 link. The Remote WTRU 301 may then send and receive data and receive with the new IP address to/from the W2N Relay 302 to communicate via the newly created PDU session.

Some solutions as described herein may implement Make-Before-Break behavior for PC5 links. A Relay (e.g., a W2N Relay WTRU) and a Remote WTRU may establish a new PDU Session or modify an existing PDU Session with new prefixes in accordance with one or more procedures described in paragraphs and figures above. Once the new PDU Session is established or modified with new prefixes, the W2N Relay may inform the Remote WTRU that a new PC5 link needs to be established. The W2N Relay may send a message to the Remote WTRU and indicate the new PC5 link request, which may include an indication of a timeout value or timeout period. The timeout value may indicate how long the existing PC5 link may be preserved. The W2N Relay may provide information to identify the new PDU Session (e.g., a PDU Session ID). Identification information may be needed in cases where the W2N Relay uses multiple PDU Sessions that may serve the RSC.

Based on the received indication, the Remote WTRU may trigger a PC5 Link establishment procedure with the same Relay. The Remote WTRU may perform the link establishment procedure, which may include sending an indication that the established PC5 link is to replace another PC5 link. The Remote WTRU may include new PDU Session identification information, which may have been previously received from the Relay.

Once the new PC5 link is established and a new IP address is configured at the Remote WTRU, the Remote WTRU may start using the new PC5 link. The Remote WTRU may release the old PC5 link prior to the expiration of the timeout period.

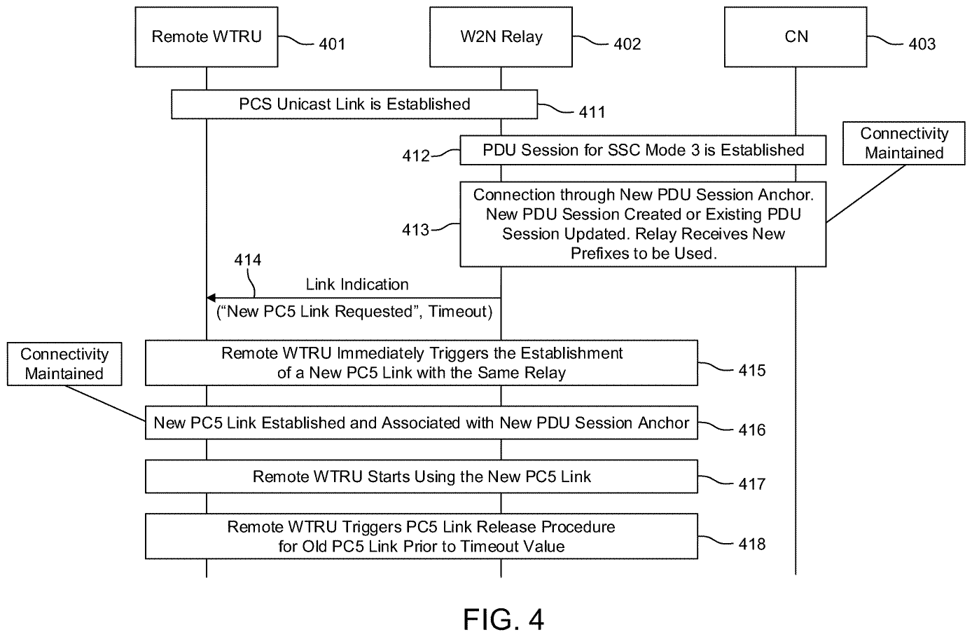

FIG. 4 is a diagram illustrating an exemplary procedure for creation of a new PC5 link. The procedure as shown may involve the sending of a “new PC5 link” indication (e.g., a make-before-break (MBB) PC5 link indication). Steps 411-413 as shown in FIG. 4 may be carried out in a similar manner as steps 311-313 as described in paragraphs above with respect to FIG. 3. As shown in FIG. 4 at 414, a W2N Relay 402 may send a message (e.g., a PC5-S message) to the Remote WTRU 401 indicating that a new PC5 link needs to be established or requesting the establishment of a new PC5 unicast link. The PC5-S message shown at 414 may be e.g., a modified Keepalive or Link Modification message, including a new indication e.g., “new PC5 link requested”, “new prefixes available”, “new PDU Session available”, a new PC5-S message (e.g., New Unicast Link Request), or Link Indication. A timeout value or period may be specified in the message indicating a length of time during which the existing PC5 link may still be used. The timeout value or period may be set according to a PDU session address lifetime value. For example the PDU session address lifetime value may be received during a procedure for creating a new PDU session or modifying an existing PDU session (e.g., as shown in step 413). Accordingly, the new PC5 link is established before the old PDU Session is released to preserve connectivity. Information to identify the new PDU Session may be included in the message send from the W2N Relay 402 to the Remote WTRU 401.

As shown at 415, the Remote WTRU 401 may receive the PC5-S message from the W2N Relay 402 and immediately trigger the PC5 link establishment procedure with the same W2N Relay 402. The Remote WTRU 401 may provide information to identify the new PDU Session if provided earlier by the W2N Relay 402. Alternatively or additionally, if the Remote WTRU 401 cannot establish a new PC5 link for some reason (e.g., max number of PC5 links reached, no resources available, etc.), the Remote WTRU 401 sends back a message indicating a rejection of the (e.g., Keepalive ACK, New Unicast Link Reject or Link Modification Reject) including the cause value.

At 416, a new PC5 link is established between the 401 Remote WTRU and the 402 W2N Relay and is associated with the new PDU Session Anchor. The W2N Relay 402 may use information to identify the new PDU Session to be associated with the new PC5 link. The Remote WTRU may start using the new PC5 link, as shown at 417. The Remote WTRU may release the old PC5 link prior to the timer expiration, as shown at 418.

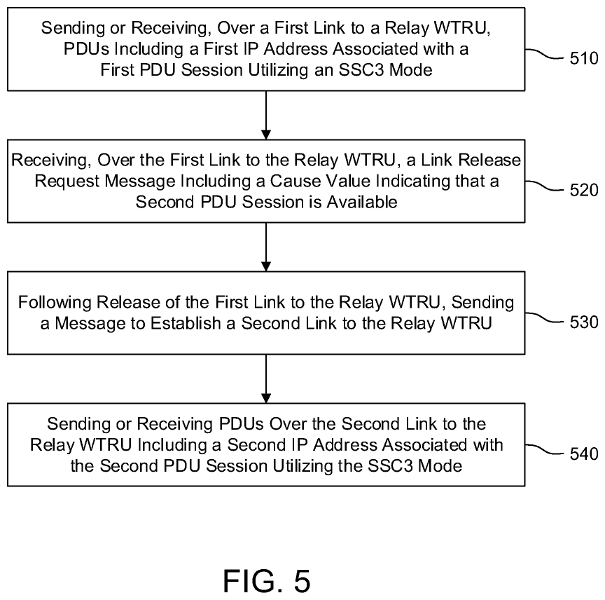

FIG. 5 is a flow chart illustrating a method for link release and re-establishment initiated based on a cause value provided by a relay WTRU. As shown in FIG. 5, at 510 the Remote WTRU may communicate (i.e., send or receive PDUs), over a link (i.e., a first link) to a relay WTRU using an IP address associated with a first PDU session. The first PDU session utilizes an SSC3 mode. At 520, the Remote WTRU receives, over the link to the relay WTRU, a link release request message indicating that a second PDU session is available. The indication that the second PDU session is available may be in the form of a cause value. The Remote WTRU may respond with a link release acceptance message. Connectivity with the Relay WTRU may be lost at this stage.

The Remote WTRU and the Relay WTRU may perform a link establishment procedure to establish a second link (i.e., a new link), including the sending of messaging from the Remote WTRU to the Relay WTRU, as shown at 530. The Relay WTRU may be the same Relay WTRU that sends the link release request message received at 520. Connectivity with the Relay WTRU may subsequently be re-established. A new IP address associated with the second PDU session may be generated before or during the link establishment procedure. When the second link has established, the Remote WTRU may communicate by sending or receiving PDUs over the second link to the Relay WTRU including the new IP address associated with the second PDU session, which also utilizes the SSC3 mode, as shown at 540.

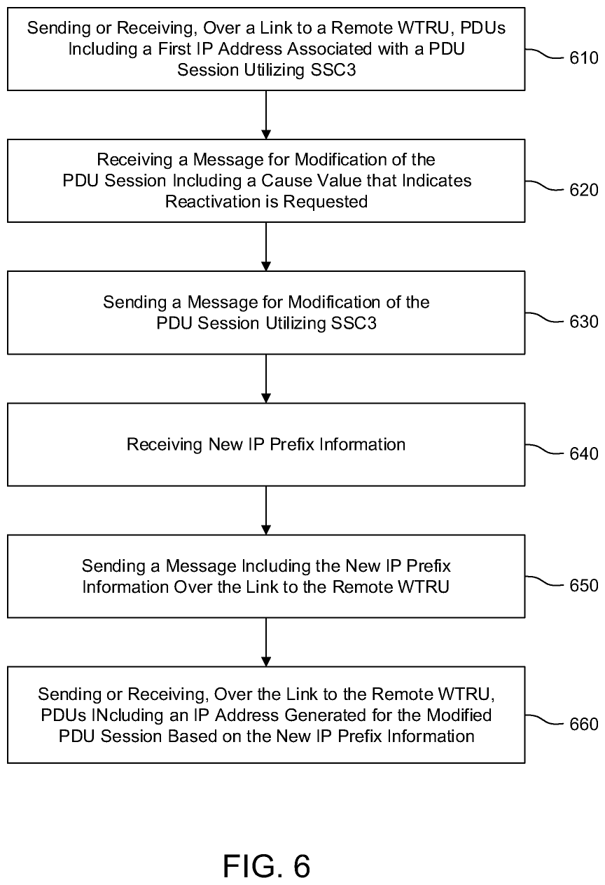

FIG. 6 is a flow chart illustrating a method performed by a Relay WTRU for providing IP prefixes to a Remote WTRU. As shown in FIG. 6, at 610, the Remote WTRU may be sending or receiving PDUs over a link to a Remote WTRU and may be in communication with a Network (i.e., the CN or a CN entity). The PDUs include a first IP address associated with a PDU session utilizing an SSC3 mode. At 620, the WTRU receives a message from a network for modification of the PDU session including a cause value that indicates reactivation is requested. At 630, the WTRU sends a message to the Network for modification of first PDU session utilizing the SSC3 mode. The WTRU receives new IP prefix information from the Network (e.g., within a message received during a PDU session e modification procedure), as shown at 640. The WTRU sends an advertisement including new IP prefix information to the Remote WTRU over the existing link, as shown at 650. At 660, after the Remote WTRU has generated a new IP address based on the provided IP prefix information, the Relay WTRU and the Remote WTRU communicate PDUs that include the new IP address associated with the modified PDU session.

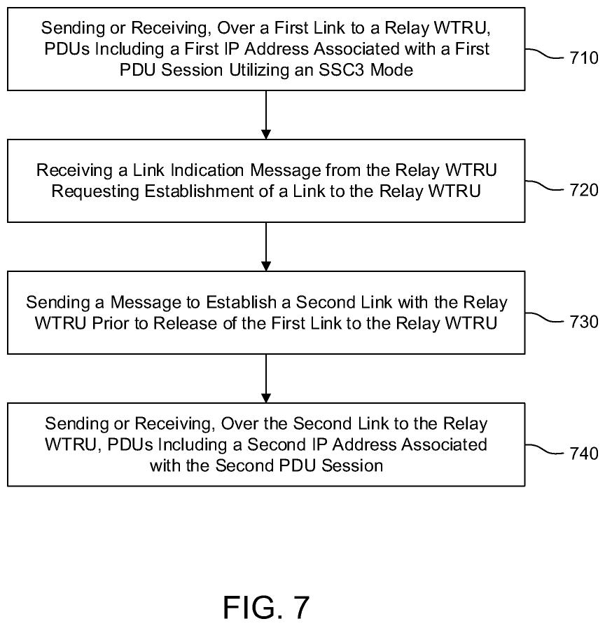

FIG. 7 is a flowchart illustrating a method performed by a Remote WTRU exercising a make-before-break procedure for link establishment. As shown in FIG. 7 at 710, the Remote WTRU may be in communication with (i.e., sending or receiving PDUs) a relay WTRU over a first link. The PDUs including a first IP address are associated with a first PDU session which utilizes an SSC3 mode and a first PDU session anchor. At 720, the Remote WTRU receives a link indication message from the Relay WTRU indicating that a second link to the Relay WTRU should be established. This triggers the Remote WTRU to perform link establishment with the same Relay WTRU, and as shown at 730, the Remote WTRU sends messaging to establish the second link prior to release or expiration of the first link to the Relay WTRU. As shown at 740, the Remote WTRU is in communication with (i.e., sending or receiving PDUs) a relay WTRU over the second link.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) configured to serve as a relay, the WTRU comprising:
a processor; and
a transceiver;
the processor and the transceiver configured to send or receive, over a PC5 unicast link to a remote WTRU, a first protocol data unit (PDU) including a first internet protocol (IP) address associated with a PDU session utilizing session service and continuity mode 3 (SSC3);
the processor and the transceiver configured to receive, from a network node, a message for modification of the PDU session including a cause value indicating that reactivation is requested;
the processor and the transceiver configured to send a message for modification of the PDU session utilizing SSC3;
the processor and the transceiver configured to receive new IP prefix information from the network node;
the processor and the transceiver configured to send a message including the new IP prefix information over the PC5 unicast link to the remote WTRU; and
the processor and the transceiver configured to send or receive a second PDU over the PC5 unicast link to the remote WTRU, the second PDU including a second IP address generated for the PDU session based on the new IP prefix information.

2. The relay WTRU of claim 1, wherein the message sent to the remote WTRU including the new IP prefix information is an advertisement message.

3. The relay WTRU of claim 1, the processor and the transceiver configured to send, over the link to the remote WTRU, a link indication message indicating that the new IP prefix information is available.

4. The relay WTRU of claim 3, the processor and the transceiver configured to receive, over the link to the remote WTRU, a message requesting the new IP prefix information.

5. The relay WTRU of claim 4, wherein the sending of the message including the new IP prefix information is responsive to the message requesting the IP prefix information.

6. The relay WTRU of claim 1, wherein the PDU session is associated with a first PDU session anchor and a second PDU session anchor.

7. (canceled)

8. The remote WTRU of claim 5, wherein the message requesting the new IP prefix information is a link identifier update (LIU) request message and wherein the message including the new IP prefix information is a LIU response message.

9. The relay WTRU of claim 8, wherein the processor and the transceiver are configured to receive an acknowledgment message in response to the sent message including the new IP prefix information.

10. A method performed by a wireless transmit/receive unit (WTRU) configured to serve as a relay, the method comprising:
sending or receiving, over a PC5 unicast link to a remote WTRU, a first protocol data unit (PDU) including a first internet protocol (IP) address associated with a PDU session utilizing session service and session continuity mode 3 (SSC3);
receiving, from a network node, a message for modification of the PDU session including a cause value indicating that reactivation is requested;
sending a message for modification of the PDU session utilizing SSC3;
receiving new IP prefix information from the network node;
sending a message including the new IP prefix information over the PC5 unicast link to the remote WTRU; and
sending or receiving a second PDU over the PC5 unicast link to the remote WTRU, the PDUs including a second IP address generated for the modified PDU session based on the new IP prefix information.

11. The method of claim 10, wherein the message sent to the remote WTRU including the new IP prefix information is an advertisement message.

12. The method of claim 10, further comprising sending, over the PC5 unicast link to the remote WTRU, a link indication message indicating that the new IP prefix information is available.

13. The method of claim 12, further comprising receiving, over the PC5 unicast link to the remote WTRU, a message requesting the new IP prefix information.

14. The method of claim 13, wherein the sending of the message including the new IP prefix information is responsive to the message requesting the new IP prefix information.

15. The method of claim 10, wherein the PDU session is associated with a first PDU session anchor and a second PDU session anchor.

16. (canceled)

17. The method of claim 10, wherein the message requesting the new IP prefix information is a link identifier update (LIU) request message and wherein the message including the new IP prefix information is a LIU response message.

18. The method of claim 17, further comprising receiving an acknowledgment message in response to the sent message including the new IP prefix information.
